(19) United States
(12) Patent Application Publication
(10) Pub. No.: US 2026/0361114 A1
(43) Pub. Date: Nov. 12, 2026

(54) SYSTEMS AND METHODS FOR MANAGING BATTERY CELLS

(71) Applicant: ENERGIZAI, INC., Vernon Hills, IL (US)

(72) Inventors: Jingsong XIA, Hawthorn Woods, IL (US); Bowei SONG, Hawthorn Woods, IL (US); Yingying FAN, Hawthorn Woods, IL (US)

(73) Assignee: ENERGIZAI, INC., Vernon Hills, IL (US)

(21) Appl. No.: 19/201,875

(22) Filed: May 7, 2025

(51) Int. Cl. H02J 7/96; H02J 7/00; H02J 7/80; H02J 7/90

(52) U.S. Cl. CPC H02J 7/96; H02J 7/855; H02J 7/927; H02J 7/80

(57) ABSTRACT

Systems and methods for managing battery cells and a non-transitory computer-readable storage media thereof are provided. A system may include a cell detection device configured to detect and monitor status of multiple individual battery cells; a switching device configured to activate or bypass, based on the status of the multiple individual cells, an individual cell or a series group comprising the individual cell; and a pulse modulation control device configured to regulate charging or discharging of the multiple individual battery cells.

### FIELD

The present disclosure is related to battery management, and in particular but not limited to, systems and methods for managing battery cells.

### BACKGROUND

Battery packs configured in series-parallel arrangements are widely used in high-demand applications due to their ability to deliver both high voltage and large capacity. In these configurations, multiple battery cells are connected in series to achieve the desired operating voltage, while several such series groups are connected in parallel to scale the overall capacity of the battery pack.

A significant challenge in battery systems is managing weak or defective cells. When these cells are in a battery pack, they can degrade their overall performance. A weak cell may exhibit higher impedance, lower capacity, or reduced voltage, causing imbalances within the series-parallel configuration. This situation limits the performance of the stronger cells, reducing total capacity, runtime, and efficiency.

### SUMMARY

According to a first aspect of the present disclosure, there is provided a system for managing battery cells, including: a cell detection device configured to detect and monitor status of multiple individual battery cells; a switching device configured to activate or bypass, based on the status of the multiple individual cells, an individual cell or a series group comprising the individual cell; and a pulse modulation control device configured to regulate charging or discharging of the multiple individual battery cells.

According to a second aspect of the present disclosure, there is provided a method for managing battery cells, including: detecting and monitoring, by a cell detection device, status of multiple individual battery cells; activating or bypassing, by a switching device and based on the status of the multiple individual cells, an individual cell or a series group comprising the individual cell; and regulating, by a pulse modulation control device, charging or discharging of the multiple individual battery cells.

According to a third aspect of the present disclosure, there is provided a non-transitory computer-readable storage medium for storing computer-executable instructions that, when executed by one or more computer processors, cause the one or more computer processors to perform the method according to the second aspect.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1A illustrates one series-parallel battery pack (MxN configuration) with a common voltage detection method.

FIG. 1B illustrates another series-parallel battery pack (MxN configuration) with a common voltage a detection method.

FIG. 2 illustrates a proposed battery pack configuration with series group-level switching and individual cell voltage monitoring in accordance with some examples of the present disclosure.

FIG. 3 illustrates another proposed battery pack configuration with cell-level switching for selective cell bypassing and individual cell voltage monitoring in accordance with some examples of the present disclosure.

FIG. 4 illustrates Pulse Modulation Control Circuits for charging and discharging in the proposed battery management system in accordance with some examples of the present disclosure.

FIGS. 5A, 5B and 5C illustrate multiphase pulse modulation discharge cycle with regular duty cycle, in FIG. 5A and increased/decreased duty cycle in dotted lines, in FIGS. 5B and 5C, in accordance with some examples of the present disclosure.

FIGS. 5D and 5E illustrate intra-group compensation strategies in accordance with some examples of the present disclosure.

FIGS. 6A and 6B illustrate examples of an entire series group is bypassed by reusing the Pulse Modulation Control Circuits, in accordance with some examples of the present disclosure.

FIGS. 7 and 8 illustrate examples of individual defective cells across different series groups are bypassed by switching between cells in accordance with some examples of the present disclosure.

FIG. 9 is a block diagram illustrating a system for managing battery cells in accordance with some examples of the present disclosure.

FIGS. 10-12 are flow charts illustrating a method for managing battery cells in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

The present disclosure relates to systems and methods for managing series-parallel battery pack configurations (MxN settings). It addresses the need for balance within each series and across multiple parallel strings. The systems provide monitoring and control of individual cells and/or series groups, addressing the limitations of some systems that rely on usage time or limited voltage detection. By assessing the condition of each cell through multiple parameters, the systems generate individualized plans for each cell or series group and manages weak or defective cells and groups. The present disclosure optimizes performance and lifespan without requiring redundant batteries. The systems and methods are suitable for applications requiring high reliability, efficiency, and safety, such as electric vehicles, portable electronics, and large-scale energy storage systems.

In severe scenarios in a system for managing battery cells, if a cell fails in a series group, it can either disrupt current flow or short-circuit the system. Disconnecting the entire string from the battery pack maintains overall voltage but reduces the pack's capacity. Conversely, if the problematic string with defective cells remains connected, it lowers the voltage across the pack, affecting overall performance. Multiple failures may render the battery pack inoperative, leading to significant capacity loss and costly repairs. Additionally, weak or defective cells pose safety risks such as overheating, overcharging, or thermal runaway if not managed promptly.

In a regular battery string (series) configuration, maintaining balance within the series is the primary focus. However, in an MxN series-parallel configuration, complexity increases as the system must also ensure balance between multiple parallel strings. This dual-level balancing is critical to prevent imbalances that can lead to reduced performance, efficiency, and safety risks.

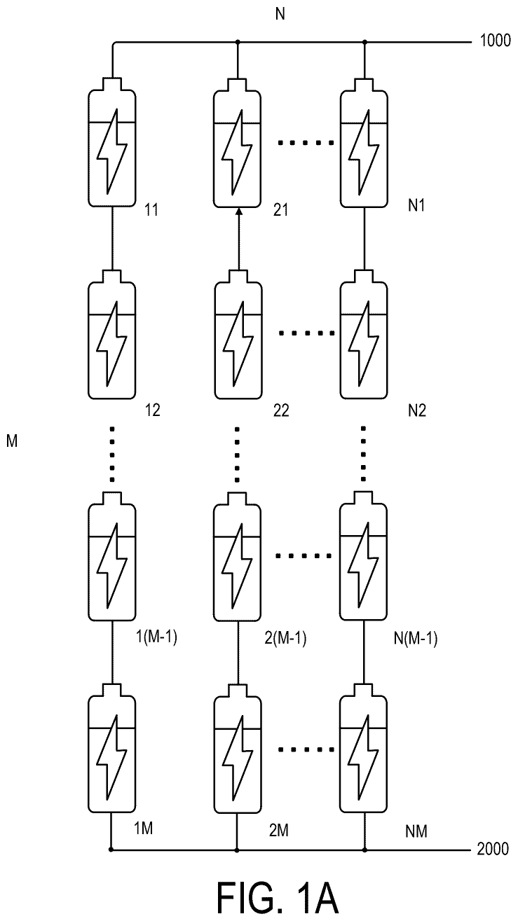

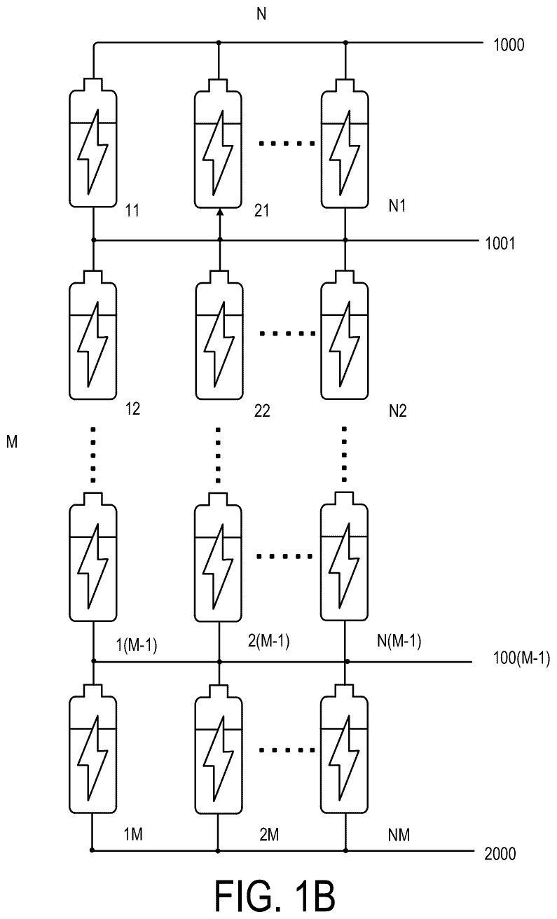

Some systems may monitor limited parameters like voltage at certain group levels. For example, a battery pack configuration, as illustrated in FIGS. 1A and 1B, consists of M cells connected in series within each series group, and these series groups are connected in parallel to form an MxN battery matrix, where M and N are respectively positive integers. In the simplest configurations, only the overall port voltage V_{CC} (1000) and V_{DD} (2000) of the series-connected battery pack is measured, as shown in FIG. 1A. Some advanced configurations, as shown in FIG. 1B, connect cells of the same order across different series groups (e.g., cells 11, 21, . . . , N1; cells 12, 22, . . . , N2; . . . ; cells 1M−1, 2M−1, . . . , NM−1; cells 1M, 2M, . . . , NM) to enable combined voltage detection V₁ (1001), V₂ (1002), . . . , V_{M-1} (100(M−1)), V_{DD} (2000)). However, these configurations operate on assumptions that all cells of the same order across different series groups are identical, with no differences in voltage, capacity, current, temperature, or impedance. Furthermore, they assume that all series groups are uniform, with no significant variation among them.

These incorrect assumptions cause serious issues. Direct connections between cells of the same order in different series groups lead to charge and discharge imbalances. Similarly, direct connections between series groups cause the same problems. If any cells or series groups are defective, the system cannot treat them differently from healthy ones, which accelerates their degradation with each charge and discharge cycle, resulting in faster failure of the entire series or battery pack.

Furthermore, some systems assess battery cell status based on usage time, but this approach is inaccurate. Varied factors like voltage, capacity, current, temperature, and impedance differ between cells, causing performance variations even with similar usage times. Consequently, relying solely on usage time leads to in inaccurate assessments and suboptimal battery management.

Therefore, the current challenges in defective cell management includes the following:

First is Lack of Individual Cell Monitoring: Current systems often cannot monitor the status of individual cells, as shown in FIGS. 1A and 1B, which only measure the overall voltage of the series or combined voltage of the same-order cells across series groups. Without individual cell monitoring, it is difficult to detect when a single cell becomes weak or defective.

Second is Lack of Individual Cell Control: Existing configurations cannot also control individual cells within the series. This inability to manage each cell independently means that when a cell begins to weaken or fail, it degrades the performance of the entire battery pack, resulting in voltage loss, cell imbalances, and safety risks.

Third is Impact of Weak Cells: When a cell in a series group becomes weak, it limits the overall system's performance. Current methods do not adequately address these weak cells, resulting in a reduction of the battery pack's efficiency and capacity, safety concerns, and the need for more frequent maintenance and replacements. As a result, weak cells play a crucial role in determining the lifespan and performance of the battery pack.

Fourth is Impact of Defective Cells: When a cell in a series group becomes defective, the entire series group may need to be disconnected and replaced, leading to the loss of functionality of the whole pack. This situation causes significant performance degradation and may require costly repairs or replacements, even when only one or a few cells are defective.

Various existing methods are employed to mitigate the impact of weak or defective cells in a battery pack. The followings are some of these existing methods:

The first technique is passive balancing, which is primarily used during charging. In this technique, excess energy from cells that reach full charge earlier is dissipated as heat through resistors, preventing those cells from being overcharged. This issue arises in series-connected battery packs, where the same charging current flows through all cells. If one cell is weak-due to lower capacity or higher internal resistance—it may reach its full charge sooner than others. Since charging continues for the remaining cells, cells that are not yet full continue to charge, potentially pushing already-full cells into overcharge conditions. Passive balancing prevents this issue by bleeding off energy from the cells with higher voltage, thereby keeping the voltage across the entire string within safe limits. However, this technique does not support maintaining the rated voltage during discharging if weak or defective cells are present.

Second is active balancing which is also used during charging. In this technique, energy is transferred from higher-voltage cells to lower-voltage cells to equalize the charge across the series. While this method is more efficient than passive balancing, it cannot compensate for weak or defective cells that cannot hold a charge and it introduces risks such as potential overcharging, which can lead to thermal runway and safety hazards. However, this technique does not support maintaining the rated voltage during discharging if weak or defective cells are present.

Third, some advanced battery management systems can detect and report defective cells or series within the pack. However, these systems often cannot continue to use or bypass (i.e., isolate) only the weak or defective cells, leading to the unnecessary replacement of entire series groups, which increases costs and downtime for maintenance. In the present disclosure, the term bypass and the term isolate are used interchangeably.

Fourth, another approach involves incorporating redundant cells that are activated when weak or defective cells are detected. While this method can temporarily maintain voltage and capacity, it only works within the limit of available redundancy-such as one or two extra cells per group-beyond which the system fails in the same manner as conventional designs. Moreover, adding redundancy increases the cost, size, and complexity of the battery pack, requiring additional switching and control circuitry to manage transitions. These drawbacks render redundancy-based solutions impractical for many real-world applications where space, weight, and efficiency are critical factors.

Given the limitations of existing methods, there is a clear need for a more efficient, reliable, and cost-effective approach to managing weak or defective cells within a battery pack. Current practices cannot monitor and control individual cell statuses, leading to performance degradation, safety risks, and increased costs.

The present disclosure addresses these challenges by providing a novel solution that not only monitors and identifies weak and/or defective cells but also controls each cell independently. The systems provided dynamically and adaptively adjust the charging and discharging process, implementing individualized plans for each cell or series to optimize performance and ensure safety. The present disclosure aims to maintain the overall rated output voltage of the battery pack, extend its usable life, reduce maintenance needs, and enhance both safety and efficiency.

The present disclosure provides systems and methods for managing the additional complexity of the MxN series-parallel battery pack configuration. By detecting and monitoring individual cells, the systems identify their status and dynamically adjust the charging and discharging processes for each cell or series group to maintain balance within each series and between series groups, without the need for redundancy batteries. The systems generate individualized plans for cells or series groups and bypasses defective battery cells or entire series groups when necessary. These systems may be achieved through a combination of cell detection circuits, switching devices (including but not limited to MOSFETs, relays, solid-state relays (SSRs), transistors), multiphase Pulse Modulation Control Circuits (including but not limited to Pulse Width Modulation (PWM), Pulse-Frequency Modulation (PFM), or any pulse sequence in any kind of Pulse Modulation Control Circuit that maintains the same duty cycle), and a central controller for comprehensive monitoring and control.

A key feature of the present disclosure is its ability to detect and monitor the status of individual cells. By independently tracking parameters such as port voltage, the systems can collect critical data to assess each cell's condition. Additional parameters, including but not limited to, State of Charge (SoC), State of Health (SoH), current, temperature, and impedance, can also be monitored for more detailed analysis. While the figures in the present disclosure do not show these parameters, a person skilled in the art would understand that these parameters can be integrated without altering the structure of the systems provided in the present disclosure. These functions may be implemented by a cell detection device which may include one or more cell detection circuits. This comprehensive detecting and monitoring approach ensures a more accurate assessment of each cell's status compared to relying solely on usage time-which can be misleading due to variations in cell conditions- or group-level voltage, which incorrectly assumes uniform conditions across all cells in a group.

Based on the information collected, the central controller in the systems may identify the status of each cell and implement individualized plans for each cell or series group to maximize the usage and lifespan of the battery pack. The followings are some examples of different scenarios.

In some examples of normal operation, when all cells or series groups are within normal status, the central controller treats them equally during both charging and discharging, allowing equal participation in battery usage. This may maximize the performance and longevity of the battery pack without the need for special adjustments.

In some examples of weakened cells, if one or more cells show signs of weakening, such as lower voltage or reduced capacity but remain functional, the central controller may identify them as weak but not yet defective. This may create imbalances within and across series groups. In response, the central controller may generate individualized plans, either applying a uniform adjustment across each series group or creating tailored plans for each cell. This flexibility helps balance loads, allowing the battery pack to operate near its rated voltage, optimizing performance, extending runtime, and enhancing safety.

In some examples of defective cells: if one or more cells fall below a preset threshold and are determined to be defective, the central controller bypasses the defective cells or series group to maintain overall performance and safety. The systems and method provided in the present disclosure allow selectively bypassing only the defective cells or entire series groups containing them. Bypassing entire series groups simplifies the control system and maintains the pack's output voltage, though it reduces the overall capacity more. Conversely, bypassing individual defective cells requires more complex switching mechanisms and necessitates individualized charging and discharging plans for the remaining cells, but would remain at higher capacity and may be able to maintain or close to the rated output voltage.

In some examples where the number of defective cells exceeds the compensation capacity of the remaining cells, the system may be forced to disable one or more additional series groups, thereby reducing capacity to maintain the output voltage. These flexible plans prevent overcharging during charging and compensate for the loss of cells during discharging, helping the battery pack maintain its rated voltage and maximize performance while ensuring safety. The systems may also issue a warning or alarm, indicating the need for factory replacement or repair.

The present disclosure improves the overall efficiency and lifespan of the battery pack by preventing overcharging and over-discharging, ensuring that all healthy cells contribute effectively to the output. By enabling individual cell management, the systems in the present disclosure protect weak or defective cells from excessive strain, thereby prolonging the battery pack's runtime and lifespan while reducing the risk of catastrophic failures.

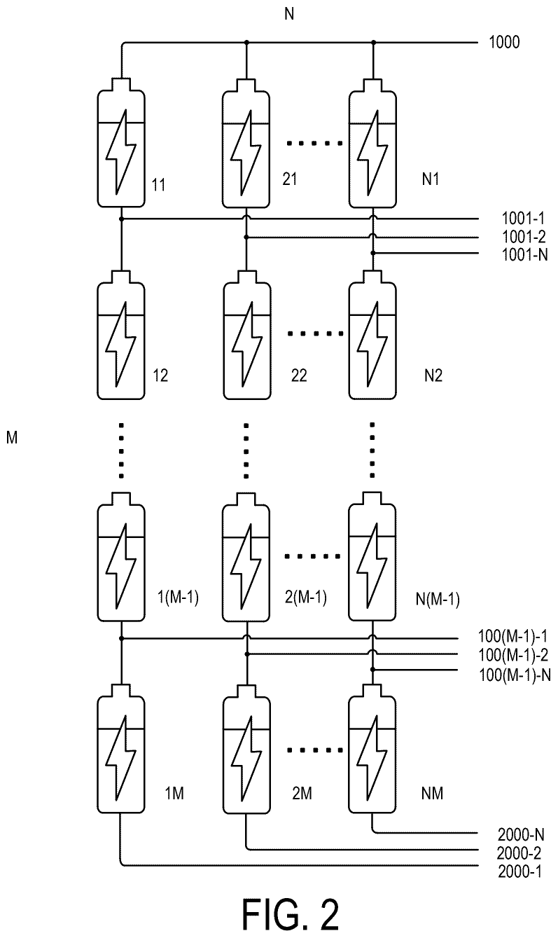

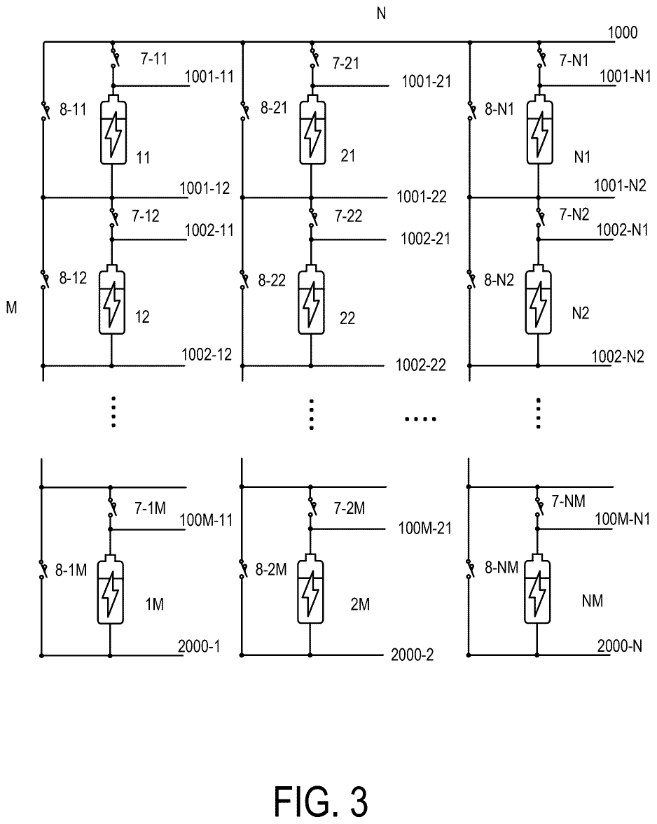

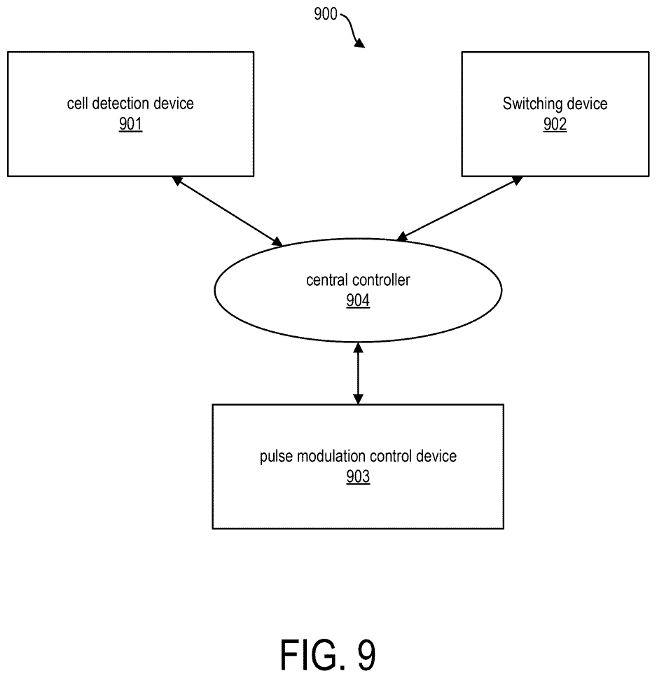

FIG. 9 illustrates a block diagram of a system 900 for managing the battery pack, as shown in FIG. 2 or 3, in accordance with some examples of the present disclosure. As shown in FIG. 9, the system 900 includes a cell detection device 901, a switching device 902, a pulse modulation control device 903, and a central controller 904.

In some examples, the system 900 may be a separate system that is capable of operating in conjunction the battery pack's Battery Management System (BMS), or serve as a replacement for the battery pack's BMS, directly managing and controlling the battery pack shown in FIG. 2 or 3.

In some examples, the cell detection device 901 may include cell detection circuits that are responsible for detecting and monitoring the status of individual cells by tracking parameters such as voltage, current, State of Charge (SoC), State of Health (SoH), temperature, and other critical metrics. This comprehensive monitoring approach provides a more accurate assessment of each cell's condition compared to relying solely on usage time or a single parameter.

In some examples, the switching device 902 may include, but not limited to, multiple switches, MOSFETs, relays, solid-state relays (SSRs), and transistors, these components allow selective activation or bypassing of cells or entire series groups.

In some examples, the pulse modulation control device 903 may include pulse modulation control circuits that regulate the charging and discharging of each series group, ensuring efficient power delivery, and preventing overcharging or over-discharging.

In some examples, the central controller 904 may process data from the cell detection device, identify cell status, and generate and execute individualized plans for each cell or series group, dynamically adjusting their contribution to the battery pack's operation.

FIGS. 1A and 2B respectively illustrates a series-parallel battery pack configuration with M cells connected in series, forming an M×N arrangement. The voltage detection occurs at the group level, which restricts accurate monitoring of individual cells.

FIG. 2 illustrates a proposed architecture where each cell within a series group is equipped with dedicated detection wires connected to the central controller. This allows for precise monitoring of both individual cells and group status. In FIG. 2, all cells in a series group are interconnected without in-cell switching, and decisions are made based on the overall group-level performance. Each cell is equipped with a wire for status detection, ensuring the accurate monitoring of individual cells and series group status, with the data relayed to the BMS. As shown in FIG. 2, there are N series groups that are parallelly arranged. Each series groups includes M cells. For example, one series group include i1, i2, . . . , iM−1, iM, where i is a positive integer from 1 to N, M and N are respectively positive integers.

While FIG. 2 denotes the detected parameter as port voltage V₁₁~V_{DDN} (1001-1~2000-N), the scope of the present disclosure may extend to detecting various other parameters, including but not limited to, current, State of Charge (SoC), State of Health (SoH), temperature, and other critical metrics. The present disclosure provides individual cell detection, allowing comprehensive monitoring beyond just voltage measurement. Any other detection method should also be considered within the scope of the present disclosure.

In addition, FIG. 2 shows that the V_{CC} (1000) line is shared across all series groups and V_{DD} (2000-i) lines are separate, where i is a positive integer from 1 to N. However, the present disclosure is not limited to the structure shown in FIG. 2. In some examples, the configuration can be reversed, i.e., the V_{DD} line is shared across all series groups and V_{CC} lines are separate.

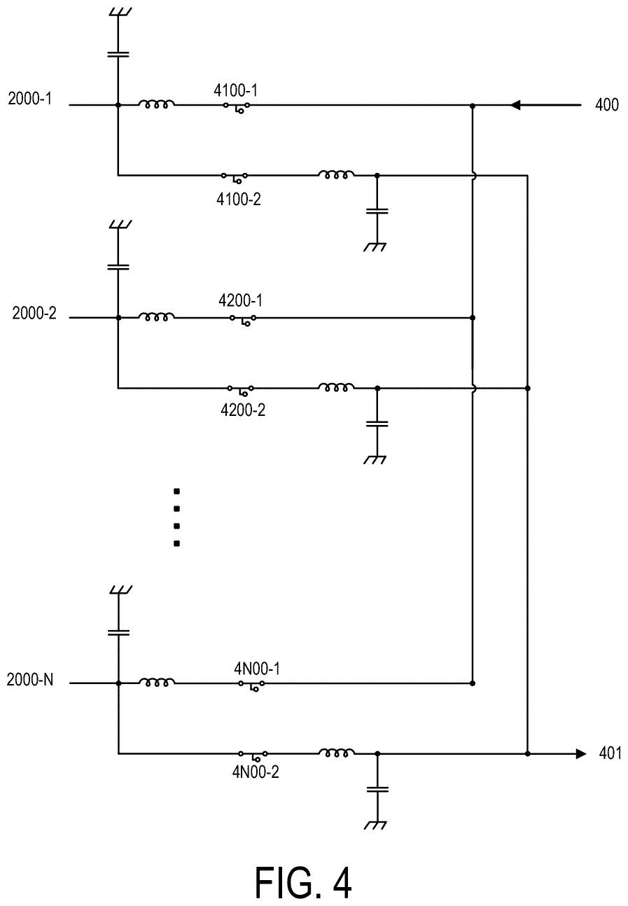

In FIG. 2, since all cells within a series group are interconnected without in-cell switching, decisions are based on the performance of the entire series group. If one or more cells in a series group begin to degrade but remain above a preset threshold, the central controller designates the series group as “weak” and adjusts its charging and discharging strategies accordingly. During charging, the central controller may decrease the voltage or current, extend the charging time, and reduce the charging speed for the weak series group or groups to prevent overcharging and potential safety risks. During discharging, the central controller lowers the duty cycle of the weak series group, thereby reducing its contribution to the total output. Simultaneously, the central controller increases the duty cycle (or frequency) of the healthy series groups within safe operating limits to compensate for the reduced output from the weak series group or groups. These adjustments are facilitated by the separate pulse modulation control device including pulse modulation control device circuits, which are shown in FIG. 4, for each series group, enabling individualized control of each series group's performance. Additionally, by employing a multiphase pulse modulation method during discharging, each series group discharges at a separate time or phase, preventing imbalance issues. This ensures that stronger series groups do not inadvertently discharge into weaker ones, which could lead to energy loss due to imbalance and inefficiency. The multiphase pulse modulation approach enhances overall energy utilization by maintaining separation between discharging phases, thereby reducing the risk of energy being lost to weaker series groups and improving the efficiency of the entire battery pack.

In some examples, if a cell or series group degrades further and falls below a preset threshold, making it defective, the central controller may bypass the entire series group. This prevents the defective cells from reducing overall performance, causing imbalance, or introducing safety risks such as overcharging, overheating, or leakage, which could damage other cells. The bypass may be accomplished by adding a series group-level switch, including but not limited to MOSFETs, relays, SSRs, transistors, at one end of each series group (not shown in FIG. 2), determining whether to activate or bypass the series group when a fault is detected.

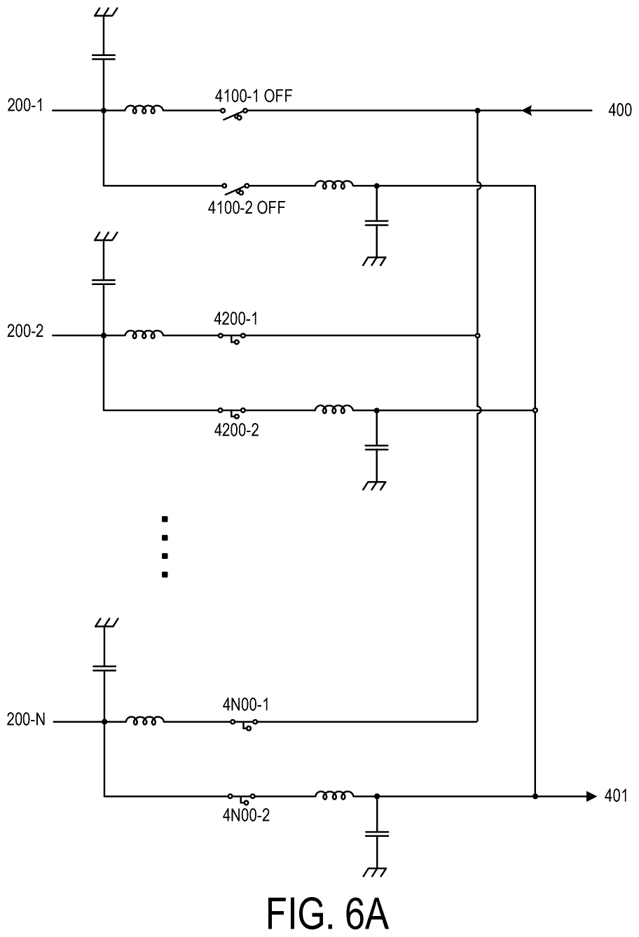

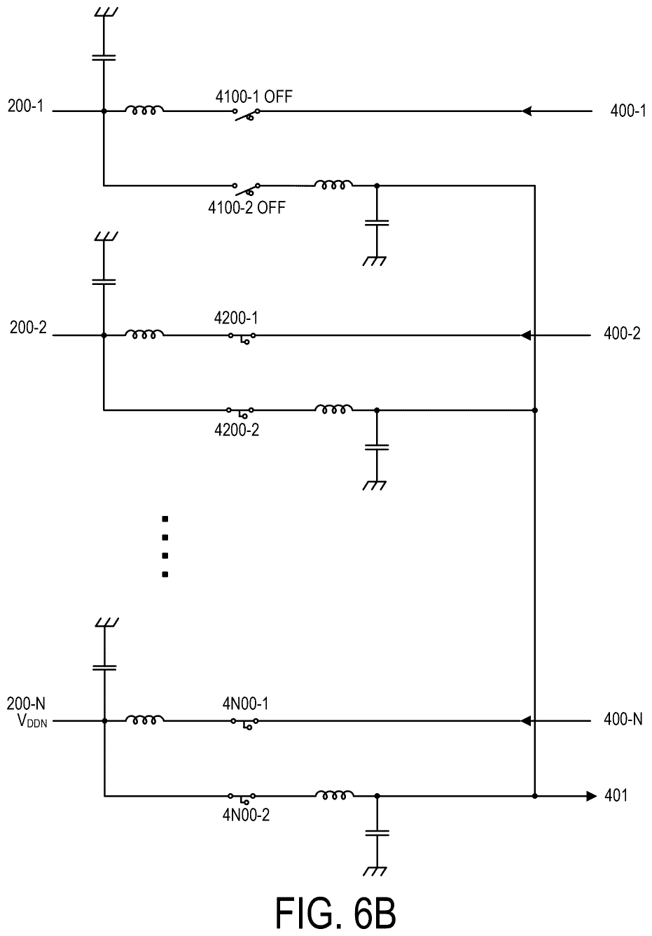

In some examples, the series group switch may be omitted by using the pulse modulation control device that includes the pulse modulation control circuits, as shown in FIGS. 6A and 6B, controlling bypass and activation status.

The series group-level switching simplifies the system architecture, reducing complexity while maintaining essential functionality. By removing series groups containing defective cells, the system may maintain output voltage with reduced capacity, avoiding performance degradation, imbalance, or safety concerns. This allows the battery pack to continue operating without immediate repair or replacement.

FIG. 3 illustrates a more precise control system allowing for individualized control of each cell within a series group in accordance of some examples of the present disclosure. Unlike the structure shown in FIG. 2, where cells are directly connected in series, FIG. 3 incorporates in-cell switching, enabling the selective bypassing or activation of individual cells within a series group.

As shown in FIG. 3, each cell is connected to its neighboring cell above and below it via two switching devices: a bypass switch 8-xy and an activation switch 7-xy, where x and y represent the order of the cell and the series group, respectively. For example, the cell 12 is connected into the series group when the activation switch 7-12 is activated (“on”) and the bypass switch 8-12 is deactivated (“off”); the cell 12 is bypassed from the series group when the activation switch 7-12 is deactivated (“off”) and the bypass switch 8-12 is activated (“on”); the cell 21 is connected to into the series group when the activation switch 7-21 is activated (“on”) and the bypass switch 8-21 is deactivated (“off”); and the cell 21 is bypassed from the series group when the activation switch 7-21 is deactivated (“off”) and the bypass switch 8-21 is activated (“on”).

These switches, 8-xy, 7-xy, which include but are not limited to MOSFETs, relays, solid-state relays (SSRs), transistors, or similar switching devices, are configured to operate in an opposing manner. For example, when the bypass switch (SB_{xy}) is activated, the corresponding activation switch (7-xy) is deactivated, and vice versa. This ensures that only one of the switches is “on” at any given time, allowing for precise control over whether the cell participates in the series group or is bypassed.

FIG. 3 displays all switches in the “off” position for clarity, which does not represent their typical operation. In practical operation, 8-xy and 7-xy will not be off simultaneously; they operate in opposing manner to each other to manage the cell's contribution to the series group. And the in-cell switching circuits 7-xy shown in FIG. 3 are placed above each cell. FIG. 3 is only exemplary and the scope of the present disclosure is not limited to FIG. 3. In some examples, the switches 7-xy may be placed below the cells. This allows for versatile implementation based on specific application requirements, which is an essential aspect of the present disclosure. Additionally, although FIG. 3 shows that the V_{CC} (1000) line is shared across all series groups and V_{DD} (2000-i) lines are separate, the present disclosure is not limited to the structure shown in FIG. 3. In some examples, the configuration can be reversed, i.e., the V_{DD} line is shared across all series groups and V_{CC} lines are separate.

In the present disclosure, the operation status of the in-cell switching device will not interfere with the cell detection device's functioning. Regardless of whether a cell is bypassed or activated in the battery pack, it remains connected to the cell detection device. FIG. 3 demonstrates that each cell is monitored through two wires (100y-x1 and 100y-x2) to detect its port voltage. However, this is just an example, and the system can monitor other parameters with different nomenclatures and connection methods. FIG. 3 is only exemplary and the scope of the present disclosure is not limited to FIG. 3.

Moreover, even though the central controller is not depicted in FIGS. 2-4, it is an integral part of the system. It is correctly connected with other parts of the system, receiving signals, and sending out commands as needed. This connectivity ensures that the central controller can seamlessly manage the operation of the in-cell switching device and the cell detection device, maintaining the efficiency and safety of the entire battery pack.

The in-cell switching configuration allows individual cells within a series group to be bypassed without affecting the entire series group. This provides significantly more flexibility compared to series group-level bypassing, as it allows the system to maintain or get close to the overall output voltage and capacity of the battery pack, even when individual cells become weak or defective.

If a cell is weak but not fully defective, the system can continue to utilize it while adjusting its charging and discharging patterns.

During charging, the central controller may implement individualized charging plans by either charging all cells or series groups simultaneously or charging each cell one at a time or charge each group one at a time.

In some examples, the central controller may charge all cells or series groups simultaneously by applying distinct voltage, current, time, and speed to each series group through separate pulse modulation control circuits based on their status. For series groups that contain weak cells, the central controller may reduce the charging speed, by lowering the charging current and/or voltage to prevent overcharging. To manage the imbalance between weak and healthy cells within the same group, one approach is to bypass weak cells once they reach full charge, thereby allowing continued charging of the remaining cells with adjusted overall charging parameters for the series group. Alternatively, by employing in-cell switching, the central controller may implement a pulsed bypass/activation schedule that applies an intermediate duty cycle to weak cells, so that they receive a reduced, intermittent charging current or voltage, enabling both weak and healthy cells within the series group to reach full charge together.

In some examples, the central controller may also charge cells or series groups sequentially, either one cell at a time or one group at a time. When charging cells individually, the system can apply a fully tailored charging plan for each cell, although the overall charging time is extended. Similarly, when charging each group individually, the central controller may connect all cells in the series group and continue charging until weak cells reach full charge and are then bypassed, or it may apply distinct duty cycles to individual cells—with lower duty cycles for weak cells-so that each cell reaches its optimal full charge without being overcharged. Although this individualized charging method increases the total charging duration, it accommodates the unique needs of each cell, mitigates imbalances, and reduces potential safety risks.

During discharging, the multiphase pulse modulation method allows different series groups to discharge at staggered times rather than simultaneously. This separation prevents imbalances between groups from causing stronger groups to unintentionally back-feed or charge weaker ones, which could result in energy loss or inefficiency. To manage groups containing weak cells, the central controller can reduce their discharge duty cycles, thereby lowering their output while increasing the duty cycles of healthier groups to compensate. When in-cell switching is available, the controller can further refine discharge management by modulating each cell's contribution within a group. Weak cells can be assigned lower duty cycles-contributing intermittently rather than continuously—while stronger cells in the same group maintain or slightly increase their output. This intra-group compensation approach enables the series group to remain operational without stressing weaker cells. Compared to group-level adjustments, intra-group control offers finer balancing and preserves more capacity. Inter-group compensation, while simpler, is effective in architectures with or without in-cell switches. Together, these strategies optimize performance, extend battery life, and maintain stable output even in the presence of weak cells.

In some examples, when a cell becomes defective-such as when it can no longer hold a charge or falls below a defined threshold voltage—the system may bypass only that specific cell using the in-cell switching mechanism, rather than bypassing the entire series group. This targeted bypassing, i.e., bypassing specific cell(s) in a series group, preserves the contribution of the remaining healthy cells within the group, avoiding unnecessary capacity loss and maintaining more of the battery pack's performance. During charging, the central controller recognizes the reduced number of active cells within the affected group and dynamically adjusts charging parameters such as the cycle and the V_{Charge} (400) voltage to prevent overcharging the remaining cells. For example, if one of ten cells in a group is bypassed, the system may reduce the charging voltage proportionally, aligning it with the capacity of the remaining nine cells.

During discharging, several strategies may be used to compensate for the reduced output caused by the absence of the defective cell. First, intra-group compensation may be applied, where the remaining healthy cells within the same series group increase their discharge duty cycles to share the additional load. Second, inter-group compensation may be implemented by increasing the duty cycles of other fully functional series groups to make up for the shortfall. In many examples, both intra-group and inter-group methods may be used together to optimize performance and preserve battery longevity. Intra-group compensation provides a more localized and balanced load-sharing approach within the group, which may be beneficial when only a small portion of the battery pack is affected. Inter-group compensation, on the other hand, simplifies control logic and reduces thermal or electrical stress on the affected group, especially when in-cell switching is not available in all series groups. By combining these strategies, the system can maintain stable output voltage and functionality, even in the presence of cell-level failures, thereby enhancing safety, reliability, and the overall lifespan of the battery pack.

FIG. 4 illustrates the pulse modulation control device 903 including pulse modulation control circuits in accordance with some examples of the present disclosure. It is important to note that, despite the explicit reference to or denoted as PWM (Pulse Width Modulation), pulse frequency modulation (PFM) or any pulse sequence control generated in any kind of pulse modulation control circuit that maintains the same duty cycles are encompassed within the scope of the present disclosure. These circuits play a critical role in managing the charging and discharging processes of the battery pack. They enable precise control over energy flow to and from each series group, ensuring the system operates efficiently under varying cell conditions.

The pulse modulation control circuits in the system may include an LC network, charging switches PWM_{CHy} (4y00-1), and discharging switches PWM_{Oy} (4y00-2). In FIG. 4, the voltage of the series-connected cells in each group is represented as V_{DD1} (2000-1) through V_{DDN} (2000-N), while V_{CHARGE} (400) serves as the reference voltage for charging.

The LC network, including an inductor and a capacitor, smooths the pulsed output from the pulse modulation signals, converting the on/off switching into a stable DC voltage that corresponds to the pulse modulation duty cycle and the reference voltage for charging. This allows for precise control over the voltage applied to or drawn from each group of cells.

The central controller may govern the operation of the pulse modulation control circuits in three primary ways.

In some examples, the central controller may manage the activation or bypassing of each series group via the charging switches PWM_{CHy} (4y00-1) and discharging switches PWM_{Oy} (4y00-2), including but not limited to MOSFETs, relays, solid-state relays (SSRs), transistors. The charging switch PWM_{CHy} dictates whether a group participates in the charging process, whereas the discharging switch determines if the group contributes to the discharging process. For instance, in configurations without in-cell switches, enabling the charging switch in the pulse modulation control circuits allows the entire group to engage in charging. Once the group is fully charged, the central controller deactivates the charging switch to prevent overcharging, ensuring other groups continue to charge unaffected. In configurations featuring in-cell switches, the system may further refine control by determining which specific cells within the group should be charged or bypassed, thereby enhancing precision.

In some examples, the central controller may adjust the pulse modulation duty cycle or frequency to precisely regulate energy flow during both charging and discharging. A higher duty cycle or pulse frequency results in a greater average voltage during charging or a higher current draw during discharging, while a lower duty cycle reduces the energy flow accordingly. This dynamic modulation allows the system to tailor energy delivery based on the real-time condition of each series group or individual cell.

For instance, groups containing weak or defective cells—or those where some cells have been bypassed due to nearing full charge—may be assigned lower duty cycles or pulse frequencies to prevent overcharging. In contrast, healthy groups continue with regular duty cycles to maintain optimal performance. During discharging, this mechanism ensures that different groups or cells contribute varying levels of energy to match their capabilities, enabling overall balance and reliability.

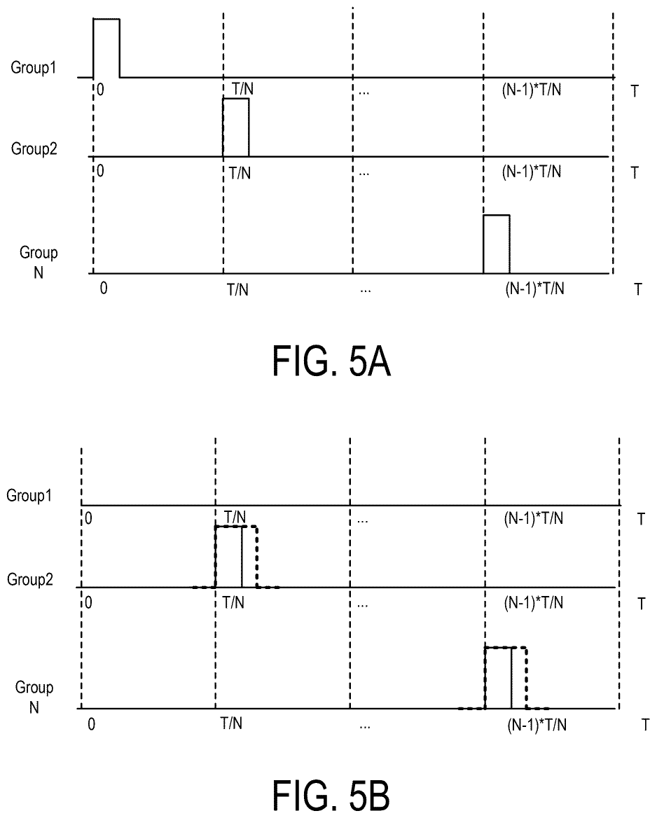

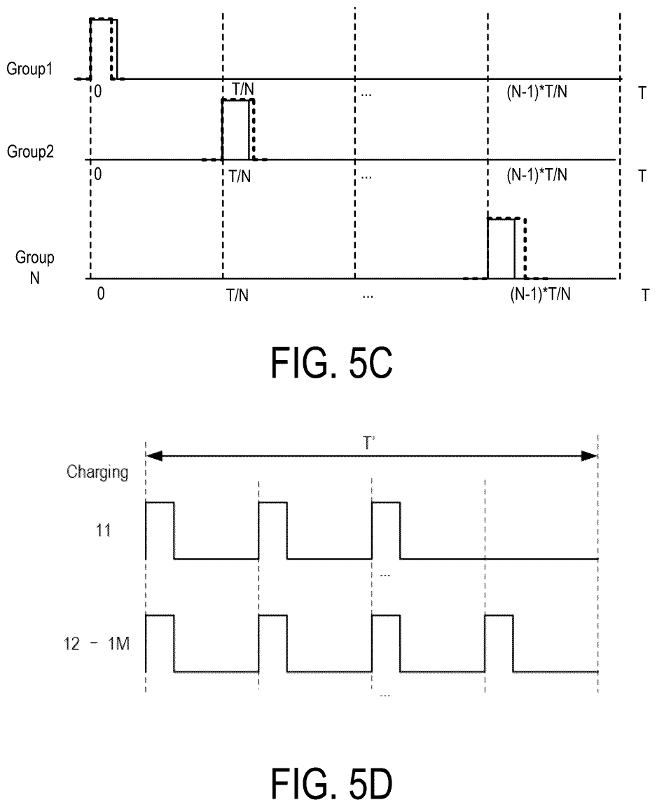

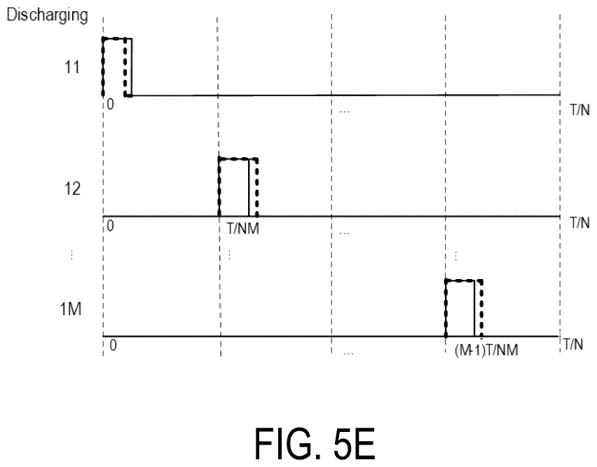

FIG. 5A illustrates a multiphase pulse modulation discharge cycle in which all groups operate with regular duty cycles. FIG. 5B shows a scenario where Group 1 has been fully bypassed due to the presence of defective or significantly weak cells, resulting in no discharge duty cycle for Group 1. The dotted lines represent increased duty cycles for the remaining groups, demonstrating inter-group compensation. FIG. 5C provides an alternate example where Group 1 remains active despite containing weak cells. In this case, Group 1 operates with a reduced duty cycle, while other groups operate with proportionally increased duty cycles, again illustrating inter-group compensation.

Additionally, FIGS. 5D and 5E illustrate intra-group compensation strategies. In FIG. 5D, during charging in a certain period of time T′, a weak cell such as cell 11 in Group 1 is charged using a lower duty cycle, while the other healthy cells in the same group (e.g., cell 12 through cell 1M) are charged at normal duty cycle. In FIG. 5E, during discharging, cell 11 again operates at a reduced duty cycle or frequency, while the remaining healthy cells (e.g., cell 12 through cell 1M) in the group contribute with slightly increased duty cycles or frequency to offset the weak cell's reduced output. These figures demonstrate how intra-group compensation—adjusting energy flow within a single group—can work in conjunction with or in place of inter-group strategies to maintain consistent system performance. FIG. 5E illustrates discharging for all cells in Group 1, in which one Group (e.g., Group 1) may receive a total time slot from time 0 to time T/N and one cell in this Group may receive one-Mth of the total time slot. Group 1 may be a series group including cells 11, 12, . . . , 1M, Group 2 may be a series group including cells 21, 22, . . . , 2M, and GroupM may be a series group including cells N1, N2, . . . , NM, as shown in FIG. 3.

In some examples, the central controller may regulate the charging voltage V_{CHARGE} (400) applied during the charging process. FIG. 6A illustrates a single V_{CHARGE} shared across all groups. FIG. 6B illustrates distinct V_{CHARGE} voltages (400-1, 400-2, . . . , 400-N) for each group. The interplay between the duty cycle and the V_{CHARGE} voltages (400-1, 400-2, . . . , 400-N) determines the final voltage delivered to each series group. For instance, by increasing the duty cycle or frequency, the system can maintain the same charging efficiency with a lower overall voltage, thereby reducing the requirement for high-capacity components. This adaptability allows the system to optimize the charging process, ensuring that weak cells or groups nearing full charge are not overcharged, and fully charged cells are bypassed. Furthermore, this configuration facilitates the use of lower-rated components, which can contribute to cost reduction and ease of maintenance.

During the charging process, V_{CHARGE} (400) is connected to a charging switch, referred to as 4i00-1 (i=1, 2, . . . , N), as shown in FIG. 4, which receives control signals from the central controller. These signals determine the activation state of the charging switch and regulate the charging voltage, duration, and rate for each group. Following the charging switch, the LC network smooths the signal, and the voltage is supplied to the 2000-i (i=1, 2, . . . , N) of each group. If a series group reaches full charge or contains defective cells that need bypassing, the central controller deactivates the charging switch for that group. When a group is approaching full charge or has weak cells, the central controller may modify the charging rate by reducing the duty cycle or frequency or lowering V_{CHARGE} (400), thus fine-tuning the group's charging parameters and preventing overcharging while ensuring balance across the battery pack.

The system employs a multiphase pulse modulation method that staggers the discharge cycles of each series group, preventing simultaneous discharges. Each group may be assigned its own time slot for discharging; these time slots may either be identical-such as the example where each group discharges for T/N or they can vary. In situations where some groups are weaker, they can be assigned shorter time slots, while healthier groups receive longer ones to maintain balance.

In some examples, each group may discharge in fixed-width pulses in turn. These pulses may be uniform in number across all groups or can differ, allowing weaker groups to discharge less frequently. For instance, a weaker group might be allocated fewer discharge pulses compared to the healthier groups.

The guiding principle is that if the discharges do not occur simultaneously, any variety in discharge timing or pulse count falls within the scope of the present disclosure. This staggered approach allows groups to take turns contributing to the load, avoiding imbalances from simultaneous discharges and ensuring that no group inadvertently charges another. Voltage variations between groups are neutralized by the sequential discharge process, which ensures that all current is directed toward the load rather than being lost through internal energy transfers between groups. Additionally, by staggering the discharge phases, the load on each individual switch is reduced, allowing the system to use lower-rated components and reducing costs without compromising performance.

In one embodiment, a battery pack has four series groups (N=4), each containing 10 cells (M=10) connected in series, resulting in a nominal group voltage of 37V (with each cell having a nominal voltage of 3.7V). The cell detection device detects that certain cells in different groups are weak, while others are defective.

The cell detection device continuously monitors the status of individual cells by tracking various parameters, primarily voltage in this embodiment. The system collects data from the cell detection circuits in the cell detection device to evaluate the condition of each cell.

For example, the system may detect whether an individual battery is weak based on one of followings: referencing a predefined lookup table for cell voltage, manual setup or adjustment by users, or automatic determination by an algorithm implemented in the central controller.

In some examples, based on a predefined lookup table, the system may determine the status and devises a corresponding plan of action.

In one example, normal cells may include cells with a voltage above 3.5V and will be treated equally during both charging and discharging. Weak Cells may include cells with a voltage between 3.0V and 3.5V. The system may generate individualized plans for these cells or series groups. Defective cells may include cells with a voltage below 3.0V. The system bypasses these cells or series groups to maintain overall performance and safety.

TABLE 1
Lookup Table for Cell Voltage Status

| Cell Voltage (V) | Status |
|---|---|
| >3.5 | Normal |
| 3.0-3.5 | Weak |
| <3.0 | Defective |

In one example, the system detects the following cell voltages in the battery pack:
Group 1:11 (3.2V), 12 (3.6V), 13 (3.7V), . . . , 110 (3.7V)
Group 2:21 (3.7V), 22 (2.8V), 23 (3.7V), . . . , 210 (3.7V)
Group 3: All cells are normal (3.7V)
Group 4: All cells are normal (3.7V)

In this example, the system will identify 11 in Group 1 as weak and generate an individualized plan for it. The system will identify 22 in Group 2 as defective and bypass it.

For Group 3 and Group 4, the system may charge the normal cells in Groups 3 and 4 as usual, and discharge Groups 3 and 4 with higher duty cycles to compensate for the loss from Group 1 and Group 2. The increased duty cycles may be determined by algorithm, formula, or according to the predefined lookup table. For example, increase by 7.5% for both groups.

For Group 1, during charging, the system may lower the charging voltage for Group 1 to a percentage compared to normal charging, which may be determined by algorithm, formula, or according to the predefined lookup table, to prevent overcharging and optimize performance. For example, lower by 5%. During discharging, the system may reduce the duty cycle of Group 1 due to its voltage loss in weak cell C11. The decreased duty cycles can be determined by algorithm, formula, or according to the predefined lookup table. For example, reduce by 3%.

For Group 2, the system may bypass the defective cell 22 in Group 2 to maintain overall performance and safety. During charging, the system may lower the charging voltage for Group 2 to a percentage compared to normal charging, which may be determined by algorithm, formula, or according to the predefined lookup table, to prevent overcharging and optimize performance. For example, lower by 10%. During discharging, the system may reduce the duty cycle of Group 2 due to its voltage loss in defective cell 22. The decreased duty cycles can be determined by algorithm, formula, or according to the predefined lookup table. For example, reduce by 10%.

By following these steps, the system ensures that the battery pack operates efficiently and safely, even with the presence of weak and defective cells. Additionally, the system leverages inter-group compensation by dynamically adjusting the performance of healthier groups to balance the overall output, thereby maintaining stability and functionality across the battery pack.

Another embodiment may utilize group-level switches without in-cell switching to manage the charging and discharging operations for each series group. The battery pack includes four series groups (N=4), each containing 10 cells (M=10) connected in series, producing a nominal group voltage of 37V per group (with each cell having a nominal voltage of 3.7V).

In this embodiment, the system identifies one or more defective cells in Group 1, causing the group's capacity and voltage to drop significantly below those of the other groups. Consequently, Group 1 is unable to operate at its rated 37V, with its actual output voltage closer to 30V, which is inadequate for proper functionality.

To maintain system balance and avoid performance degradation, the system decides to bypass Group 1 entirely. This is achieved by deactivating both the charging switch PWM_{CH1} (4100-1) and the discharge switch PWM_{O1} (4100-2) for Group 1, as shown in FIGS. 6A and 6B, effectively bypassing it from both the charging and discharging processes. With Group 1 being bypassed, it no longer participates in energy storage or delivery.

The remaining groups—Group 2, Group 3, and Group 4—continue to function normally, each delivering the full 37V during discharge. The system actively regulates these groups via their respective pulse modulation control circuits. The system adjusts the duty cycle of the operational groups, as shown in FIG. 5B, to be 30% more than normal, to compensate for the loss of Group 1 while maintaining the battery pack's output voltage near the rated level.

By bypassing Group 1, the system mitigates potential issues such as overcharging or over-discharging that could arise due to the defective cells in that group. Although the overall capacity of the battery pack is reduced as Group 1 is no longer contributing, the system's output voltage remains stable at 37V, ensuring effective operation without necessitating immediate repair or replacement.

In this embodiment, the absence of in-cell switches simplifies the structure, as the system controls the entire group with only two switches, one for charging and one for discharging. While bypassing Group 1 results in a reduced capacity, the system continues to provide the rated output voltage, ensuring continuous operation with minimal risk of imbalance or safety concerns.

Another embodiment includes Group 1 including 10 cells (M=10), each with a nominal voltage of 3.7V, connected in series without in-cell switches, resulting in a group voltage of 37V. The battery pack includes four series groups (N=4) connected in parallel. The system identifies that three cells in Group 1 exhibit reduced capacity and lower voltage compared to other groups, indicating they are weak but not defective. Consequently, Group 1 cannot sustain the standard charging speed and discharging duty cycle without causing imbalances in the system.

To address this issue, the system uses an individualized charging plan for Group 1. It reduces the charging voltage by setting its duty cycle to 70% or/and setting a lower V_{CHARGE1} (400-1) while other groups may get a full 100% duty cycle and V_{CHARGE} (400-i), i=2−N. This prevents overcharging and lowers the risk of overheating or over-voltage. The system also extends the charging duration for Group 1 by slowing the charging speed, allowing weak cells to reach full capacity gradually.

During discharging, the system similarly reduces the duty cycle for Group 1, enabling it to contribute 30% less than the other groups. Concurrently, the system increases the duty cycle of the healthier groups (Groups 2 and 4) to compensate for the decreased contribution from Group 1. For example, Group 2 may operate at 110% of its normal duty cycle, and Group 4 at 120%, as shown in FIG. 5C. This dynamic adjustment ensures that the battery pack continues to function at or near its rated voltage (37V per group) while accommodating the diminished performance of Group 1.

The system continuously monitors the status of Group 1 and the other groups, dynamically adjusting the charging and discharging parameters to optimize the overall performance and lifespan of the battery pack.

In another embodiment, the battery pack has four series groups (N=4), each containing 10 cells (M=10) connected in series with in-cell switches, resulting in a nominal group voltage of 37V. The system detects that certain individual cells in separate groups are defective and require bypassing to maintain system performance. For instance, Cell 11 (the first cell in Group 1) and Cell 42 (the second cell in the last Group) are identified as defective due to excessive internal resistance and inability to hold a charge.

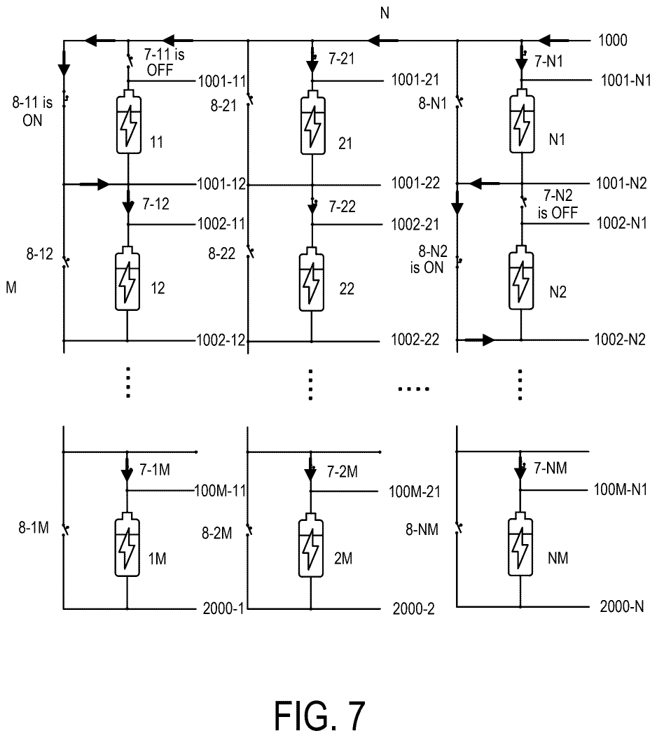

To ensure that defective cells do not compromise the performance of their respective groups, the system employs in-cell switching to bypass Cell 11 and Cell 42 without bypassing their entire groups. By deactivating the activation switch (7-11) and activating the bypass switch (8-11) in Group 1, as well as making corresponding adjustments in Group 4, the system bypasses the defective cells while maintaining the functionality of the remaining cells within the groups. This approach allows the groups to continue contributing to the battery pack's output voltage and capacity. This process is illustrated in FIG. 7, where N in the diagram equals 4.

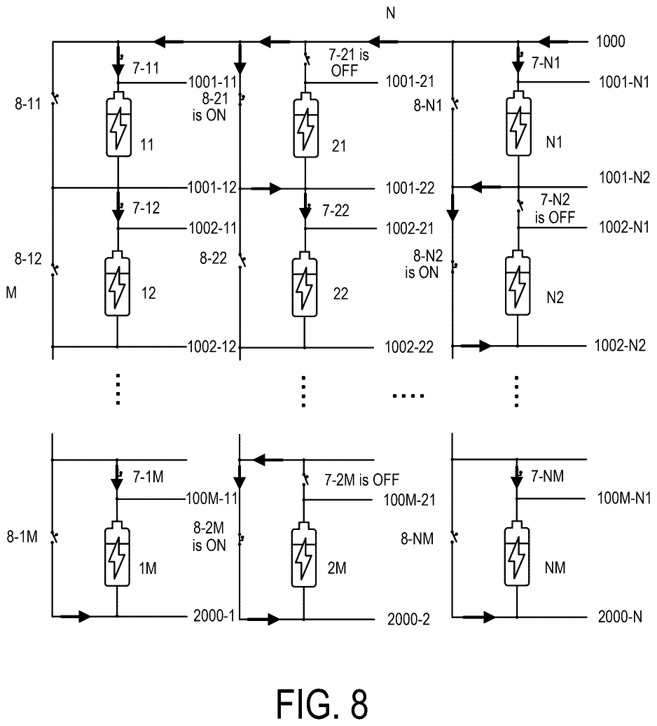

While bypassing the defective cells slightly reduces the overall group voltage—for instance, Group 1 now operates at 33.3V with 9 active cells instead of the full 37V—the system compensates by increasing the duty cycle of the healthy cells within the affected group (Group 1). This intra-group compensation enables Group 1 to maintain or approach its rated voltage during discharge. Furthermore, the system may also adjust the pulse modulation settings for other groups (e.g., Groups 2 and 3) to provide inter-group compensation. This adjustment helps distribute the burden of the affected group with lost cells and optimizes the output voltage of the entire battery pack. This process is illustrated in FIG. 8.

In another embodiment, the system optimizes the charging process by bypassing fully charged cells within series groups. The battery pack includes four series groups (N=4), each containing 10 cells (M=10), with a nominal group voltage of 37V. During the charging process, the BMS monitors each cell individually to determine when they achieve full charge.

For instance, in Group 2, Cell 21 and Cell 2M (the first and last cells in the group) reach their full charge capacity before the others. To prevent overcharging, the system activates the bypass switches (8-21, 8-2M) for these fully charged cells and deactivates their corresponding activation switches (7-21, 7-2M). By excluding these cells from the charging process, the system prevents overcharging while continuing to charge the remaining cells in Group 2. Similarly, in Group 3, Cell 32 also reaches full charge, and the central controller bypasses it using the same method.

With these cells excluded, the system adjusts the V_{CHARGE} voltage (400/400-i) and the pulse modulation duty cycle to reflect the reduced number of cells still participating in the charging process. For example, the system might lower the V_{CHARGE2} (400-2) from 37V to 29.6V for Group 2, ensuring that the remaining 8 cells are charged safely and efficiently, and lower the V_{CHARGE3} (400-3) from 37V to 33.3V for Group 3.

By bypassing the fully charged cells, the system ensures that each group charges evenly without risking overcharging, thereby maintaining the health and safety of the battery pack. The system's capability to adaptively adjust the charging voltage based on the number of remaining active cells guarantees optimal charging performance while preventing potential safety issues.

Compared to passive and active balancing systems, the present disclosure offers notable advantages. Passive balancing dissipates excess energy as heat, which is inefficient and hazardous, and may not be accurate as charging currents change while the battery approaches the target voltage. Active balancing involves transferring energy between cells, which is more efficient but complex and costly.

The present disclosure achieves the following technical benefits.

Individual Cell Monitoring and Dynamic Control: This system enables independent monitoring of each cell's voltage and other parameters, facilitating accurate status assessment and management of individual cells and series groups within the battery pack.

Transitional Stage Management: Before fully bypassing a cell or series group, the system implements an intermediary stage in which cells or groups with subpar performance (yet still functional) are managed differently. The central controller of the system adjusts charging voltage, time, or current, and decreases the duty cycle during discharging to optimize overall battery pack performance and extend runtime.

Selective Bypassing of Defective Cells or Series Groups: The system permits selective bypassing of individual defective cells or complete series groups using switching devices including, but not limited to, multiple switches, MOSFETs, relays, solid-state relays (SSRs), and transistors. This approach ensures that the battery pack can maintain operation at or near its rated voltage even when some cells or series groups are compromised, thereby eliminating the necessity for redundant batteries.

Multiphase Pulse Modulation Control Circuits for Charging and Discharging: The system employs Pulse Modulation Control Circuits for managing the charging process and utilizes multiphase Pulse Modulation for discharging. This technique ensures sequential discharge of series groups, preventing voltage imbalances and optimizing current distribution, which reduces the current rating requirements for each switch and potentially lowers system costs.

Capacity Compensation and Load Balancing: In instances where certain cells or series groups are weak or defective, the system compensates by adjusting the Pulse Modulation duty cycle of the remaining healthy cells. This ensures consistent output voltage and balanced utilization of the remaining capacity, thereby extending the operational life of the battery pack.

Advanced Fault Management and Safety Mechanisms: The system is equipped with sophisticated fault management features that trigger warnings or alarms when the loss of defective cells exceeds the compensation capacity, indicating the need for factory-level repairs or replacement. This ensures the safety and reliability of the battery pack during operation.

These features collectively enhance the performance, reliability, and lifespan of the battery pack, marking a significant advancement over other battery management technology.

In some examples, there is also provided a non-transitory computer-readable storage medium comprising a plurality of programs, for example, in the memory 1030, executable by the processor 1020 in the computing environment 1010, for performing the above-described methods. The non-transitory computer-readable storage medium may be, for example, a ROM, a Random Access Memory (RAM), a CD-ROM, a magnetic tape, a floppy disc, an optical data storage device or the like.

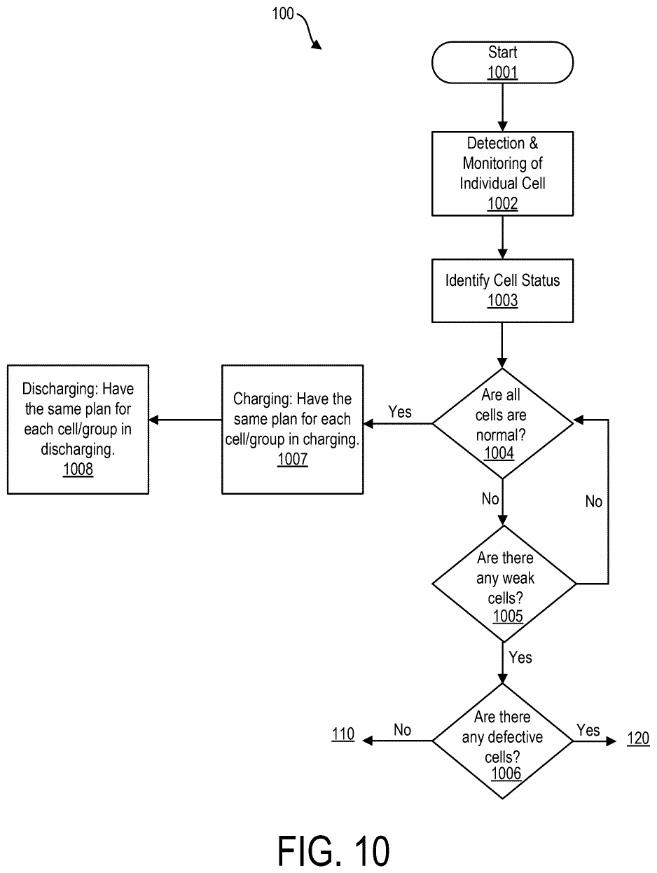

FIGS. 10-12 are flow charts illustrating methods for managing battery cells in accordance with some examples of the present disclosure. Specifically, FIG. 10's flow chart 100 includes steps 1001 to 1006. The method starts at step 1001.

At step 1002, the status of individual battery cells are detected and monitored by the cell detection device 901.

At step 1002, the central controller 904 in the system identifies the status of the individual battery cells.

At step 1003, the central controller 904 determines whether all the individual battery cells are normal.

If the central controller 904 determines, at step 1004, that all the individual battery cells are normal, the pulse modulation control device 903 implements the same plan for each cell or group in charging and discharging, as shown in steps 1007 and 1008. The charging step 1007 and discharging step 1008 shown in FIG. 10 has no specific order, i.e., there is no limitation whether the charging step 1007 is performed before the discharging step 1008 or the discharging step 1008 is performed before the charging step 1007.

If the central controller 904 determines, at step 1004, that not all the individual battery cells are normal, the central controller 904 further determines, at step 1005, whether there are any weak cells. There are various ways to determine whether there is one cell is weak, as discussed in the embodiments above.

If the central controller 904 determines, at step 1005, that there is no weak cell, the method goes back go step 1004. If the central controller 904 determines, at step 1005, that there is at least one cell is weak, the central controller 904 determines, at step 1006, whether there are any defective cells.

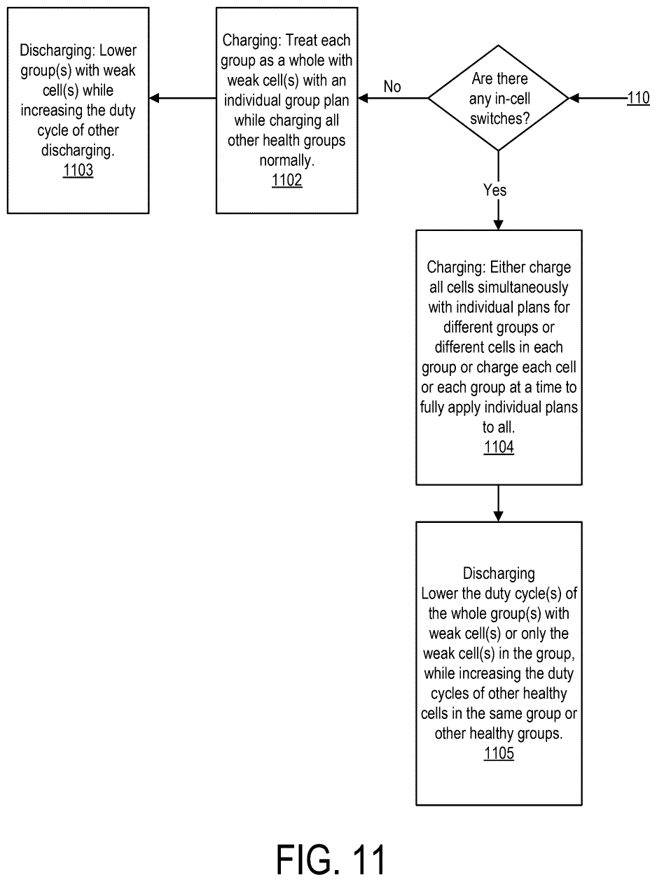

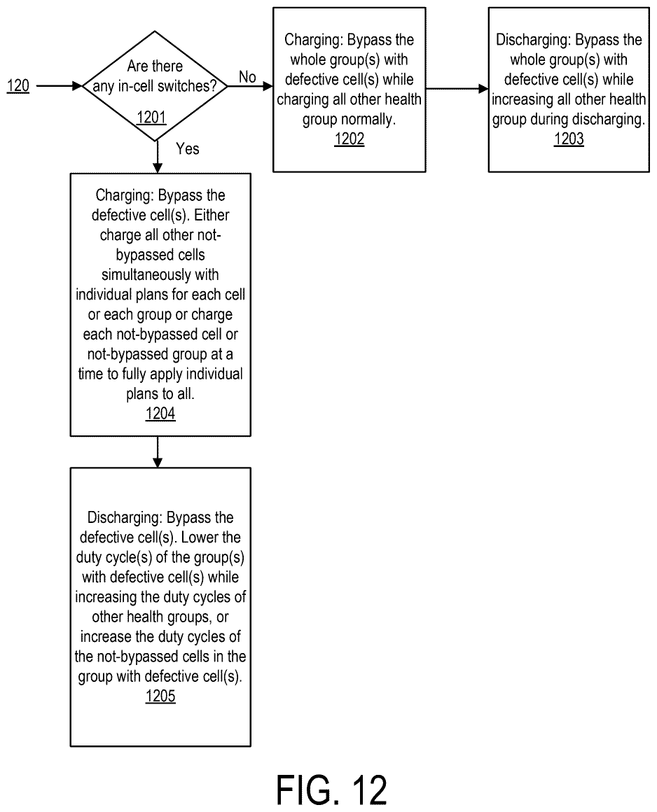

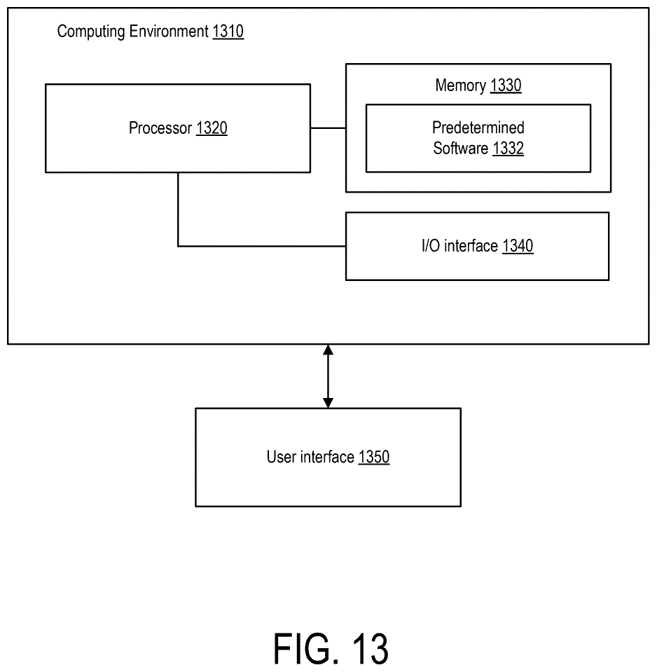

If the central controller 904 determines, at step 1006, that there is at least one cell that is defective, the method goes to the flow chart 120 as shown in FIG. 12. If the central controller 904 determines, at step 1006, that there is no cell that is defective, the method goes to the flow chart 110 as shown in FIG. 11.

As shown in FIG. 11, if the central controller 904 determines, at step 1006, that there is no cell that is defective, the central controller 904 determines, at step 1101, whether there are any in-cell switches in the system. If it is determined that there is no in-cell switch in the system, the pulse modulation control device 903 implements the step 1102 in charging and step 1103 in discharging. Specifically, in step 1102, the central controller 904 treats each group as a whole with the weak cell or cells with an individual plan while charging all other healthy groups normally; in step 1103, the central controller 904 lowers the group or groups with the weak cell or cells while increasing the duty cycle of other discharging. The step 1102 and the step 1103 shown in FIG. 11 has no specific order, i.e., there is no limitation whether the step 1102 is performed before the step 1103 or the step 1103 is performed before the step 1102.

If it is determined that there are in-cell switches in the system, the pulse modulation control device 903 implements the step 1104 in charging and step 1105 in discharging. Specifically, in step 1104, the central controller 904 either charges all cells simultaneously with individual plans for different groups, or different cells in each group, or charges each cell or each group at a time to fully apply individual plans to all; in step 1105, the central controller 904 lowers the duty cycle of the group or groups with the weak cell or cells, or only the weak cell or weak cells in the group or groups, while increasing the duty charge of other healthy groups or other healthy cell(s) in the group(s) with weak cell(s) during discharging. The step 1104 and the step 1105 shown in FIG. 11 has no specific order, i.e., there is no limitation whether the step 1104 is performed before the step 1105 or the step 1105 is performed before the step 1104.

As shown in FIG. 12, if the central controller 904 determines, at step 1006, that there is at least one cell that is defective, the central controller 904 determines, at step 1201, whether there are any in-cell switches in the system. If it is determined that there is no in-cell switch in the system, the pulse modulation control device 903 implements the step 1202 in charging and step 1203 in discharging. Specifically, in step 1202, the central controller 904 bypasses the whole group(s) with defective cell(s) while charging all other healthy group normally; in step 1203, the central controller 904 bypasses the whole group(s) with defective cell(s) while increasing all other healthy group during discharging. The step 1202 and the step 1203 shown in FIG. 12 has no specific order, i.e., there is no limitation whether the step 1202 is performed before the step 1203 or the step 1203 is performed before the step 1202.

If it is determined that there are in-cell switches in the system, the pulse modulation control device 903 implements the step 1204 in charging and step 1205 in discharging. Specifically, in step 1204, the central controller 904 bypasses the defective cell(s), and either charges all cells that are not bypassed simultaneously with individual plans for each cell or each group, or charges each cell or each group that is not bypassed at a time to fully apply individual plans to all; in step 1105, the central controller 904 bypasses the defective cell(s), lowers the duty cycle of the group(s) with defective cell(s) while increasing the duty cycle of other healthy groups during discharging, or just increase the duty cycles of the healthy and not bypassed cells in the group with defective cell(s). The step 1204 and the step 1205 shown in FIG. 12 has no specific order, i.e., there is no limitation whether the step 1204 is performed before the step 1205 or the step 1205 is performed before the step 1204.

FIG. 13 shows a computing environment 1310 coupled with a user interface 1350. The computing environment 1310 can be part of a data processing server. The computing environment 1310 includes a processor 1320, a memory 1330, and an Input/Output (I/O) interface 1340.

The processor 1320 typically controls overall operations of the computing environment 1310, such as the operations associated with display, data acquisition, data communications, and image processing. The processor 1320 may include one or more processors to execute instructions to perform all or some of the steps in the above-described methods. Moreover, the processor 1320 may include one or more modules that facilitate the interaction between the processor 1320 and other components. The processor may be a Central Processing Unit (CPU), a microprocessor, a single chip machine, a Graphical Processing Unit (GPU), or the like.

The memory 1330 is configured to store various types of data to support the operation of the computing environment 1310. The memory 1330 may include predetermined software 1332. Examples of such data includes instructions for any applications or methods operated on the computing environment 1310. The memory 1330 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1340 provides an interface between the processor 2920 and peripheral interface modules, such as a keyboard, a click wheel, buttons, and the like. The buttons may include but are not limited to, a home button, a start scan button, and a stop scan button.

In an embodiment, the is also provided a computing device comprising one or more processors (for example, the processor 1020); and the non-transitory computer-readable storage medium or the memory 1030 having stored therein a plurality of programs executable by the one or more processors, wherein the one or more processors, upon execution of the plurality of programs, are configured to perform the above-described methods.

In an embodiment, the computing environment 1010 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A system for managing battery cells, comprising:
a cell detection device configured to detect and monitor status of multiple individual battery cells;
a switching device configured to activate or bypass, based on the status of the multiple individual cells, an individual cell or a series group comprising the individual cell; and
a pulse modulation control device configured to regulate charging or discharging of the multiple individual battery cells.

2. The system according to claim 1, wherein the multiple individual battery cells are arranged in a battery pack, the battery pack comprises multiple series groups that are parallelly arranged, and each series group comprises an equal number of battery cells; and
wherein the status of the multiple individual cells comprise at least one of following parameters: voltage, current, State of Charge (SoC), State of Health (SoH), or temperature.

3. The system according to claim 2, wherein the switching device comprises a bypass switch and an activation switch,
wherein the multiple individual battery cells comprise a first individual battery cell and a second individual battery cell, the first individual battery cell and the second individual battery cell are in the same series group and the first individual battery cell is neighboring to the second individual battery cell,
wherein the first individual battery cell is connected with the second individual battery cell via the activation switch and bypassed from the battery pack via the bypass switch, and
wherein the bypass switch is configured to be activated when the activation switch is configured to be deactivated, and the activation switch is configured to be activated when the bypass switch is configured to be deactivated.

4. The system according to claim 3, further comprising a central controller configured to control the cell detection device, the switching device, and the pulse modulation control device;
wherein in response to determining that the cell detection device detects that the first individual battery cell is weak and defective, the central controller is further configured to determine whether the switching device is an in-cell switching device;
wherein in response to determining that the switching device is not an in-cell switching device, the central controller is configured to bypass a first series group that contains the first individual battery when charging other healthy series groups in the battery pack normally and configured to bypass the first series group and increase duty cycle of other healthy series groups for discharging; and
wherein in response to determining that the switching device is an in-cell switching device, the central controller is further configured to bypass the first individual battery cell for charging and configured to lower the duty cycle of the first series group and increase the duty cycle of other healthy series group for discharging.

5. The system according to claim 3,
wherein in response to determining that the cell detection device detects that the first individual battery cell is weak but not defective, the central controller is further configured to determine whether the switching device is an in-cell switching device;
wherein in response to determining that the switching device is not an in-cell switching device, the central controller is configured to treat a first series group that contains the first individual battery using an individual plan for charging and configured to lower duty cycle of the first series group and increase the duty cycle of other healthy series groups for discharging; and
wherein in response to determining that the switching device is an in-cell switching device, the central controller is further configured to charge all cells in the first series group using different plans or charge each cell in the first series at a time to fully apply individual plans to all the cell in the first series and configured to lower the duty cycle of the first series group and increase the duty cycle of other healthy series groups for discharging.

6. The system according to claim 5, wherein the cell detection device detects whether an individual battery is weak based on one of followings:
a predefined lookup table for cell voltage;
a manual set up; or
an algorithm in the central controller.

7. The system according to claim 2, wherein the pulse modulation control device comprises a plurality of pulse modulation control circuits, each pulse modulation control circuit comprises a charging switch and a discharging switch; and
wherein each pulse modulation control circuit connects to one series group and is configured to regulate the charging and the discharging of multiple battery cells in the series group.

8. The system according to claim 7, wherein each pulse modulation control circuit is further configured to adjust pulse modulation duty cycle to control energy flow during each cycle.

9. The system according to claim 7, wherein each pulse modulation control circuit is further configured to regulate a charging voltage for the series group that is connected.

10. The system according to claim 7, wherein each pulse modulation control circuit is further configured to discharge the multiple battery cells in the series group in one of following manners: in multiphase pulse modulation or in fixed-width pulses in turn.

11. A method for managing battery cells, comprising:
detecting and monitoring, by a cell detection device, status of multiple individual battery cells;
activating or bypassing, by a switching device and based on the status of the multiple individual cells, an individual cell or a series group comprising the individual cell; and
regulating, by a pulse modulation control device, charging or discharging of the multiple individual battery cells.

12. The method according to claim 11, wherein the multiple individual battery cells are arranged in a battery pack, the battery pack comprises multiple series groups that are parallelly arranged, and each series group comprises an equal number of battery cells; and
wherein the status of the multiple individual cells comprise at least one of following parameters: voltage, current, State of Charge (SoC), State of Health (SoH), or temperature.

13. The method according to claim 12, wherein the switching device comprises a bypass switch and an activation switch, the multiple individual battery cells comprise a first individual battery cell and a second individual battery cell, the first individual battery cell and the second individual battery cell are in the same series group and the first individual battery cell is neighboring to the second individual battery cell, the first individual battery cell is connected with the second individual battery cell via the activation switch and bypassed from the battery pack via the bypass switch, and wherein the bypass switch is configured to be activated when the activation switch is configured to be deactivated, and the activation switch is configured to be activated when the bypass switch is configured to be deactivated,
wherein the method further comprises:
in response to determining that a first individual battery cell is weak and defective, determining whether the switching device is an in-cell switching device;
in response to determining that the switching device is not an in-cell switching device, bypassing a first series group that contains the first individual battery when charging other healthy series groups in the battery pack normally, and bypassing the first series group and increasing duty cycle of other healthy series groups for discharging; and
in response to determining that the switching device is an in-cell switching device, bypassing the first individual battery cell for charging, and lowering the duty cycle of the first series group and increasing the duty cycle of other healthy series group for discharging.

14. The method according to claim 13, further comprising:
in response to determining that the cell detection device detects that the first individual battery cell is weak but not defective, determining whether the switching device is an in-cell switching device;
in response to determining that the switching device is not an in-cell switching device, treating a first series group that contains the first individual battery using an individual plan for charging, lowering duty cycle of the first series group and increasing the duty cycle of other healthy series groups for discharging; and
in response to determining that the switching device is an in-cell switching device, charging all cells in the first series group using different plans or charge each cell in the first series at a time to fully apply individual plans to all the cell in the first series, and lowering the duty cycle of the first series group and increasing the duty cycle of other healthy series groups for discharging.

15. The system according to claim 14, further comprising:
detecting, based on a predefined lookup table for cell voltage, whether an individual battery is weak.

16. The system according to claim 12, wherein the pulse modulation control device comprises a plurality of pulse modulation control circuits, each pulse modulation control circuit comprises a charging switch and a discharging switch, each pulse modulation control circuit connects to one series group; and
wherein the method further comprises:
regulating, by each pulse modulation control circuit, the charging and the discharging of multiple battery cells in the series group.

17. The system according to claim 16, further comprising:
adjusting, by each pulse modulation control circuit, pulse modulation duty cycle to control energy flow during each cycle.

18. The system according to claim 16, further comprising:
regulating, by each pulse modulation control circuit, a charging voltage for the series group that is connected.

19. The system according to claim 16, further comprising:
discharging, by each pulse modulation control circuit, the multiple battery cells in the series group in one of following manners: in multiphase pulse modulation or in fixed-width pulses in turn.

20. A non-transitory computer-readable storage medium for storing computer-executable instructions that, when executed by one or more computer processors, cause the one or more computer processors to perform acts comprising:
detecting and monitoring status of multiple individual battery cells;
activating or bypassing, based on the status of the multiple individual cells, an individual cell or a series group comprising the individual cell; and
regulating charging or discharging of the multiple individual battery cells.
